(19) United States
(12) Patent Application Publication
(10) Pub. No.: US 2021/0152070 A1
(43) Pub. Date: May 20, 2021

(54) PERPETUAL MOTION MACHINE HAVING INTANGIBLE ENERGY SOURCE

(71) Applicant: Taiping ZHONG, YUEYANG (CN)

(72) Inventor: Taiping ZHONG, YUEYANG (CN)

(21) Appl. No.: 17/160,363

(22) Filed: Jan. 27, 2021

Related U.S. Application Data
(63) Continuation of application No. PCT/CN2019/000157, filed on Aug. 13, 2019.

(30) Foreign Application Priority Data
Aug. 29, 2018 (CN) 201810991306.6

(51) Int. Cl. H02K 53/00; H02K 7/18; H02K 7/10; H02K 7/116; B61C 3/00; F02N 11/08

(52) U.S. Cl. CPC H02K 53/00; H02K 7/1846; F02N 11/0862; H02K 7/116; B61C 3/00; H02K 7/1004

(57) ABSTRACT

The disclosure discloses a perpetual motion machine having an intangible energy source and comprising vertical spindle. A generator is installed at the upper end of the vertical spindle, and two iron bars connected at one end so as to form a certain angle are installed at a lower end thereof. The other ends of the two iron bars are separated and form a horizontal line extending to any position in a lengthwise direction of the two iron bars, wherein one of the iron bars is connected below a central point at a front end of a single-wheel electric vehicle, and the other of the iron bars is connected below a central point at a rear end of the same single-wheel vehicle.

### CROSS-REFERENCE TO RELATED APPLICATIONS

This application is a continuation of International Patent Application No. PCT/CN2019/000157 with a filing date of Aug. 13, 2019, designating the United States, now pending, and further claims priority to Chinese Patent Application No. 201810991306.6 with a filing date of Aug. 29, 2018. The content of the aforementioned applications, including any intervening amendments thereto, are incorporated herein by reference.

### TECHNICAL FIELD

The disclosure relates to a perpetual motion machine having an intangible energy source and comprising vertical spindle. A generator is installed at the upper end of the vertical spindle, and two iron bars (namely two levers forming horizontal lines at a certain angle) connected at one end so as to form a certain angle are installed at a lower end thereof. The other ends of the two iron bars are separated to form a horizontal line extending to any position in a lengthwise direction of the two iron bars, wherein one of the iron bars is connected below a central point at a front end of a single-wheel electric vehicle, and the other of the iron bars is connected below a central point at a rear end of the same single-wheel vehicle. A battery of the single-wheel electric vehicle starts an engine of the single-wheel electric vehicle, a value of the engine being several or many times smaller than a value of the generator, but the single-wheel electric vehicle is driven by the engine, then the single-wheel vehicle pulls the two iron bars so as to drive high speed rotation of the vertical spindle, and accordingly drive the generator to generate electricity. After the generating capacity of the generator reaches a maximum rated value, the movement of the single-wheel vehicle toward the lengthwise direction of the iron bars is stopped. Meanwhile the battery is no longer used to provide power to the engine of the single-wheel electric vehicle, and the vehicle switches to use a part of electricity in the engine in a regular and perpetual manner, then the engine of the single-wheel electric vehicle perpetually uses most of electricity in the generator that is not completely consumed by the single-wheel electric vehicle to drive perpetual operation of various types of machines as needed. Support cost is zero, which is a significant breakthrough for a law of conservation of energy.

### BACKGROUND OF THE PRESENT INVENTION

In order to change the worldwide problem that human beings want to solve, but cannot be solved, the present application invents a perpetual motion machine having an intangible energy source motion machine.

### SUMMARY OF PRESENT INVENTION

1. A perpetual motion machine having an intangible energy source, comprising a generator having the intangible energy source perpetually generating electricity, wherein an engine perpetually uses electricity generated by itself to drive perpetual operation of various types of machines.

2. The perpetual motion machine having an intangible energy source according to claim 1, comprising a vertical spindle, wherein a generator is installed at the upper end of the vertical spindle, and two iron bars (namely two levers forming horizontal lines at a certain angle) connected at one end so as to form a certain angle are installed at a lower end thereof, and the other ends of the two iron bars are separated to form a horizontal line respectively.

3. The perpetual motion machine having an intangible energy source according to claim 1, comprising any position in a lengthwise direction of the two iron bars, wherein one of the iron bars is connected below a central point at a front end of a single-wheel electric vehicle, and the other of the iron bars is connected below a central point at a rear end of the same single-wheel vehicle.

4. The perpetual motion machine having an intangible energy source according to claim 1, comprising that an engine of the single-wheel electric vehicle is started by using a battery of the single-wheel electric vehicle, the vehicle is driven by the engine, then the two iron bars are pulled by the single-wheel vehicle so as to drive high speed rotation of the vertical spindle, and accordingly drive the generator to generate electricity.

5. The perpetual motion machine having an intangible energy source according to claim 1, comprising that a value of the engine of the single-wheel vehicle is several or many times smaller than a value of the generator, and the value of the engine is always kept unchanged, namely, the power consumption of the engine is kept unchanged.

6. The perpetual motion machine having an intangible energy source according to claim 1, comprising that to meet the demand on large electricity consumption of a user, the single-wheel vehicle pulls the iron bars according to grades so as to drive the rotation of the vertical spindle, wherein multiple single-wheel vehicles can be adopted to pull the iron bars so as to drive the rotation of the vertical spindle, and a railway engine can also be adopted to pull the iron bars so as to drive the rotation of the vertical spindle.

7. The perpetual motion machine having an intangible energy source according to claim 1, comprising that to meet the demand on small electricity consumption of a user, the single-wheel vehicle moves at any one position in a lengthwise direction of the two iron bars in a horizontal line to do work, such that after the generating capacity of the generator reaches a maximum rated value, the movement of the single-wheel vehicle toward the lengthwise direction of the iron bars is stopped.

8. The perpetual motion machine having an intangible energy source according to claim 1, comprising that an engine of the single-wheel electric vehicle is started by using a battery of the single-wheel electric vehicle, the single-wheel electric vehicle is driven by the engine, and then the two iron bars are pulled by then the single-wheel electric vehicle to drive high-speed rotation of the vertical spindle so as to drive the generator to generate electricity, such that after the generating capacity of the generator reaches a maximum rated value, the battery is no longer used to provide power to the engine of the single-wheel electric vehicle, and the vehicle switches to use a part of electricity in the engine in a regular and perpetual manner, then the engine of the single-wheel electric vehicle perpetually uses most of electricity in the generator that is not completely consumed by the single-wheel electric vehicle to drive perpetual operation of various types of machines as needed. Support cost is zero, which is a significant breakthrough for a law of conservation of energy.

9. The perpetual motion machine having an intangible energy source according to claim 1, comprising a runway of the single-wheel electric vehicle, which can be set as a round plane, or a circular orbit.

10. The perpetual motion machine having an intangible energy source according to claim 1, comprising that considering the rotation speed of the generator, belt pulley or gear shifting can be used.

According to the disclosure, the perpetual motion machine having an intangible energy source can be used as a generator and a host, and does not need supplementation of external energy or even external assistance, so as to produce permanent motion, clean and environmental protection, low cost and high efficiency. It is applicable to various industries, especially to airplanes, trains, automobiles and ships, is the only first choice in this field in the world. The predecessors can utilize the lever to lift the earth, however, the present application can make use of the lever to infinitely produce invisible energy, so that human beings can perpetually use electricity as needed without complete use up. Furthermore, support cost is zero, so that human beings can move for time they want to move, and human beings can live a happy life forever.

### DESCRIPTION OF THE DRAWINGS

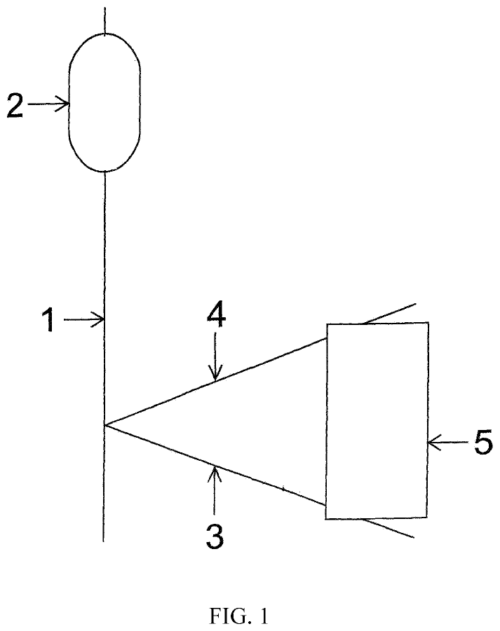

The FIG. 1 is a schematic diagram of a device according to the disclosure.

In FIG. 1, numerical 2 represents a generator.

In FIG. 1, numerical 1 represents a vertical spindle.

In FIG. 1, numerical 3 and 4 represent iron bars.

In FIG. 1, numerical 5 represents a single-wheel electric vehicle.

### DETAILED DESCRIPTION OF PREFERRED EMBODIMENTS

A vertical spindle 1 is adopted, a generator 2 is installed at the upper end of the vertical spindle, and two iron bars connected at one end so as to form a certain angle are installed at a lower end thereof, and the other ends of the two iron bars 3 and 4 are separated to form a horizontal line respectively. At any position in a lengthwise direction of the two iron bars, wherein one 3 of the iron bars is connected below a central point at a front end of a single-wheel electric vehicle 5, and the other 4 of the iron bars is connected below a central point at a rear end of the same single-wheel vehicle 5, however, the single-wheel vehicle 5 pulls the two iron bars 3 and 4 so as to drive high speed rotation of the vertical spindle 1, and accordingly drive the generator 2 to generate electricity.

We claim:

1. A perpetual motion machine having an intangible energy source, comprising a generator having the intangible energy source perpetually generating electricity, wherein an engine perpetually uses electricity generated by itself to drive perpetual operation of various types of machines.

2. The perpetual motion machine having an intangible energy source according to claim 1, comprising a vertical spindle, wherein a generator is installed at the upper end of the vertical spindle, and two iron bars (namely two levers forming horizontal lines at a certain angle) connected at one end so as to form a certain angle are installed at a lower end thereof, and the other ends of the two iron bars are separated and form a horizontal line respectively.

3. The perpetual motion machine having an intangible energy source according to claim 1, comprising any position in a lengthwise direction of the two iron bars, wherein one of the iron bars is connected below a central point at a front end of a single-wheel electric vehicle, and the other of the iron bars is connected below a central point at a rear end of the same single-wheel vehicle.

4. The perpetual motion machine having an intangible energy source according to claim 1, comprising that an engine of the single-wheel electric vehicle is started by using a battery of the single-wheel electric vehicle, the vehicle is driven by the engine, and then the two iron bars are pulled by the single-wheel vehicle so as to drive high speed rotation of the vertical spindle, and accordingly drive the generator to generate electricity.

5. The perpetual motion machine having an intangible energy source according to claim 1, comprising that a value of the engine of the single-wheel vehicle is several or many times smaller than a value of the generator, and the value of the engine is always kept unchanged, namely, the power consumption of the engine is kept unchanged.

6. The perpetual motion machine having an intangible energy source according to claim 1, comprising that to meet the demand on large electricity consumption of a user, the single-wheel vehicle pulls the iron bars according to grades so as to drive the rotation of the vertical spindle, wherein multiple single-wheel vehicles can be adopted to pull the iron bars so as to drive the rotation of the vertical spindle, and a railway engine can also be adopted to pull the iron bars so as to drive the rotation of the vertical spindle.

7. The perpetual motion machine having an intangible energy source according to claim 1, comprising that to meet the demand on small electricity consumption of a user, the single-wheel vehicle moves at any one position in a lengthwise direction of the two iron bars in a horizontal line to do work, such that after the generating capacity of the generator reaches a maximum rated value, the movement of the single-wheel vehicle toward the lengthwise direction of the iron bars is stopped.

8. The perpetual motion machine having an intangible energy source according to claim 1, comprising that an engine of the single-wheel electric vehicle is started by using a battery of the single-wheel electric vehicle, the single-wheel electric vehicle is driven by the engine, and then the two iron bars are pulled by then the single-wheel electric vehicle to drive high-speed rotation of the vertical spindle so as to drive the generator to generate electricity, such that after the generating capacity of the generator reaches a maximum rated value, the battery is no longer used to provide power to the engine of the single-wheel electric vehicle, and the vehicle switches to use a part of electricity in the engine in a regular and perpetual manner, then the engine of the single-wheel electric vehicle perpetually uses most of electricity in the generator that is not completely consumed by the single-wheel electric vehicle to drive perpetual operation of various types of machines as needed. Support cost is zero, which is a significant breakthrough for a law of conservation of energy.

9. The perpetual motion machine having an intangible energy source according to claim 1, comprising a runway of the single-wheel electric vehicle, which can be set as a round plane, or a circular orbit.

10. The perpetual motion machine having an intangible energy source according to claim 1, comprising that considering the rotation speed of the generator, belt pulley or gear shifting can be used.
